(19) United States
(12) Patent Application Publication
(10) Pub. No.: US 2014/0121901 A1
(43) Pub. Date: May 1, 2014

(54) ELECTRICAL POWER SUPPLY CONTROL SYSTEM, ELECTRICAL POWER SUPPLY CONTROL DEVICE, AND ELECTRICAL POWER SUPPLY CONTROL METHOD

(71) Applicant: Daisuke Shii, Yokkaichi (JP)

(72) Inventor: Daisuke Shii, Yokkaichi (JP)

(73) Assignees: AUTONETWORKS TECHNOLOGIES, LTD., Yokkaichi, Mie (JP); SUMITOMO ELECTRIC INDUSTRIES, LTD., Osaka-shi, Osaka (JP); SUMITOMO WIRING SYSTEMS, LTD., Yokkaichi, Mie (JP)

(21) Appl. No.: 14/127,359

(22) PCT Filed: Apr. 25, 2012
(86) PCT No.: PCT/JP2012/061029

§ 371 Date: Dec. 18, 2013

(30) Foreign Application Priority Data
Jun. 22, 2011 (JP) 2011-138806

(51) Int. Cl. B60R 16/023

(52) U.S. Cl. CPC B60R 16/0231
USPC 701/36

(57) ABSTRACT

A power source control system, a power source controller, and a power source control method capable of switching between supply and shut-off of power for electronic devices, individually for a plurality of electronic devices connected to a network, are provided. If a power source controller shuts off a power source for the Electronic Control Unit (ECU) by outputting a control signal to a power source switch device, the power source controller cyclically transmits data in place of the ECU. The other ECU for which a power source is not shut off can receive data equivalent to the data to be cyclically transmitted by the ECU for which the power source is shut off, from the power source controller. The power source controller stores a transmission cycle, a transmission ID, and latest reception information of each control target ECU, and performs substitute transmission of data.

### TECHNICAL FIELD

The present invention relates to a power source control system, a power source controller, and a power source control method that are capable of switching between supply and shut-off of power from a power source, individually for a plurality of electronic devices that perform communication via a common communication line.

### BACKGROUND ART

Conventionally, a vehicle is equipped with a plurality of electronic devices such as ECUs (Electronic Control Units), and the electric devices operate in conjunction with one another while exchanging information via a network such as a CAN (Controller Area Network), thereby achieving control for traveling of the vehicle, control associated with comfortability in the compartment, and the like. The electronic devices are connected to a power source such as a battery or an alternator of the vehicle via a power line, and operate using power supplied from the power source. In recent years, power saving is needed since the number of electronic devices mounted in a vehicle is increasing.

Patent Document 1 proposes an electronic controller including a control power source for generating a second power source from a first power source in accordance with an input of a first activation signal given by a switch input or a second activation signal from a communication line, and a device control circuit that operates in a first operation mode when being activated in accordance with the first activation signal, operates in a second operation mode when being activated in accordance with the second activation signal, and outputs a shutdown signal for stopping generation of the second power source for the control power source after finishing a predetermined operation. This electronic control device can stop power supply for the control circuit even if it is activated in accordance with the signal that is input via the communication line.

### CITATION LIST

### Patent Documents

Patent Document 1: JP 2007-133729A

### SUMMARY OF INVENTION

### Technical Problem

Power consumption can be reduced by stopping power supply from a power source, as with the electronic controller described in Patent Document 1. However, some systems in which a plurality of electronic devices perform communication via a network have a configuration in which each electronic device cyclically transmits data and determines that an abnormality has occurred in another device if no data is received from this device for a predetermined time period. The electronic device that has determined that an abnormality had occurred performs a special operation for abnormality, for example, stops processing or issues a warning. With a system having this configuration, if power supply for part of the electronic devices connected to the network is stopped, the electronic devices for which power supply is not stopped do not receive data from the electronic devices for which power supply is stopped, and accordingly determine that an abnormality has occurred. Those electronic devices that have determined that an abnormality had occurred perform their special operation for abnormality, and therefore, there is a possibility that regular operations expected to be performed by the system will not be performed.

Accordingly, in the case of a system having the above-described configuration, power supply for the electronic devices needs to be simultaneously stopped for all electronic devices connected via the network. Since the conditions that allow all electronic devices to be stopped are limited, a problem arises in that a sufficient effect of a reduction in power consumption cannot be achieved. Alternatively, stop of power supply for part of the electronic devices can be achieved by taking a measure of, for example, changing processing of the electronic devices such that if power supply for part of the electronic devices is stopped, these electronic devices are excluded from being considered for the determination of abnormality occurrence based on the presence of received data. However, this makes it necessary to change the content of processing of all electronic devices connected to the network, and a problem arises in that it cannot be easily carried out.

The present invention was made in light of the forgoing situation, and an object of the present invention is to provide a power source control system, a power source controller, and a power source control method that are capable of switching between supply and shut-off of power, individually for each of a plurality of electronic devices connected to a network.

### Solution to Problem

A power source control system according to the present invention is a power source control system including: a plurality of electronic devices each having a communication means for cyclically transmitting data to a common communication line to which the communication means are connected, and for receiving data cyclically transmitted from another device, and a detection means for detecting a communication abnormality if cyclic data from the other device is not received for a predetermined time period; and a power source controller having a switching control means for performing control for switching between supply and shut-off of power from a power source, individually for the respective electronic devices, the power source controller including: a communication means connected to the communication line, for transmitting and receiving data to and from the electronic devices; and a substitute transmission means for transmitting data to be cyclically transmitted by an electronic device, using the communication means, if the switching control means shuts off power for that electronic device.

Further, in the power source control system according to the present invention, the power source controller may include a storage means storing identification information attached to data transmitted by the electronic devices, and cycles in which the respective electronic devices transmit data, and the substitute transmission means may be configured to transmit data including the identification information stored in the storage means in the respective cycle stored in the storage means.

Further, in the power source control system according to the present invention, the power source controller may include a storage means for storing data received from the electronic devices by the communication means, and the substitute transmission means may be configured to transmit data including a last data received from an electronic device for which power is shut off by the switching control means.

Further, the power source control system according to the present invention may further include a plurality of second electronic devices each having a communication means for cyclically transmitting data to a second communication line that is different from the communication line and to which the communication means are connected, and for receiving data cyclically transmitted from another device, and a detection means for detecting a communication abnormality if cyclic data from the other device is not received for a predetermined time period, wherein the power source controller may have a second switching control means for performing control for switching between supply and shut-off of power from a power source, individually for each second electronic device, and the second switching control means may be configured to shut off power for the second electronic devices for a shorter time period than the predetermined time period.

Further, a power source controller according to the present invention may be a power source controller including a switching control means for performing control for switching between supply and shut-off of power from a power source, individually for each of a plurality of electronic devices connected to a common communication line, the power source controller including: a communication means for transmitting and receiving data to and from the electronic devices connected to the communication line; and a substitute transmission means for transmitting data to be cyclically transmitted by an electronic device, using the communication means, if the switching control means shuts off power for that electronic device.

Further, a power source control method according to the present invention may be a power source control method for switching between supply and shut-off of power from a power source, individually for each of a plurality of electronic devices each having a communication means for cyclically transmitting data to a common communication line to which the communication means are connected, and for receiving data cyclically transmitted from another device, and a detection means for detecting a communication abnormality if cyclic data from the other device is not received for a predetermined time period, the method including: transmitting data to be cyclically transmitted from an electronic device in place of the electronic device if power for the electronic device is shut off.

In the present invention, the power source controller may switch between supply and shut-off of power from a power source, individually for each of the electronic devices connected to the common communication line. The power source controller may be connected to the communication line shared by the electronic devices and thus able to communicate with the electronic devices, and cyclically transmits data in place of an electronic device for which power is shut off. As a result, the other electronic devices receive data equivalent to the data to be transmitted by the electronic device for which power is shut off, from the power source controller, and can therefore continue to perform regular processing without detecting a communication abnormality. Accordingly, supply and shut-off of power for each electronic device connected to the common communication line can be individually switched without changing processing of the electronic devices, and power consumption can be thus reduced.

Further, in the present invention, the power source controller may store the identification information such as an ID (Identifier) attached to the data transmitted by each electronic device, and the data transmission cycle of each electronic device. When the power source controller performs substitute transmission, it transmits data including the stored identification information (other included information may be dummy information) in the stored cycle. With this configuration, the power source controller can easily performs substitute transmission for the electronic device for which power is shut off.

Further, in the present invention, when the electronic devices perform a normal operation and cyclically transmit data, the power source controller may receive and store the data transmitted by the electronic devices. When the power source controller performs substitute transmission, it transmits data (which may be data identical to the last data) including the last data received from the electronic device for which power is shut off. For example, if the electronic device transmits information regarding results of sensor detection, operational status of a switch, or the like, the power source controller can perform substitute transmission of data including the information regarding the last detection result or operational status.

In the present invention, if the system includes the plurality of second electronic devices that are not connected to the common communication line shared with the power source controller but connected to the second communication line that is different from the common communication line, the power source controller cannot perform substitute transmission. For this reason, for these second electronic devices, the power source controller shuts off power only during a shorter time period than a time period for detecting an abnormality when no data is received. The power source controller switches the power source so as to supply power after a lapse of this time period, and thus, the second electronic devices start to operate and cyclically transmit data. The other second electronic devices can receive data before detecting an abnormality. Further, the power source controller may shut off power again after the second electronic devices transmit data, and can reduce power consumption by repeating supply and shut-off of power.

### Advantageous Effects of Invention

With the present invention, the power source controller connected to the common communication line shared by the plurality of electronic devices is configured to cyclically transmit data in place of an electronic device for which power is shut off, and it is therefore possible to switch supply and shut-off of power individually for each electronic control device without the electronic devices detecting an abnormality. Consequently, power consumption of the entire system can be effectively reduced.

### BRIEF DESCRIPTION OF DRAWINGS

FIG. 1 is a block diagram showing a configuration of a power source control system according to Embodiment 1 of the present invention.

FIG. 2 is a block diagram showing a configuration of a power source switch device and a power source controller.

FIG. 3 is a block diagram showing a configuration of an ECU.

FIG. 4 is a schematic diagram for illustrating communication processing performed by the power source control system according to Embodiment 1 of the present invention.

FIG. 5 is a table showing an example of information for substitute transmission stored in a storage unit in the power source controller.

FIG. 6 is a flowchart showing a procedure of processing performed by the power source controller.

FIG. 7 is a block diagram showing a configuration of a power source control system according to a variation.

FIG. 8 is a block diagram showing a configuration of an ECU according to a variation.

FIG. 9 is a block diagram showing a configuration of a power source control system according to Embodiment 2 of the present invention.

FIG. 10 is a schematic diagram for illustrating intermittent control performed by a power source controller according to Embodiment 2.

FIG. 11 is a flowchart showing a procedure of processing performed by the power source controller according to Embodiment 2.

### DETAILED DESCRIPTION OF THE EMBODIMENTS

### Embodiment 1

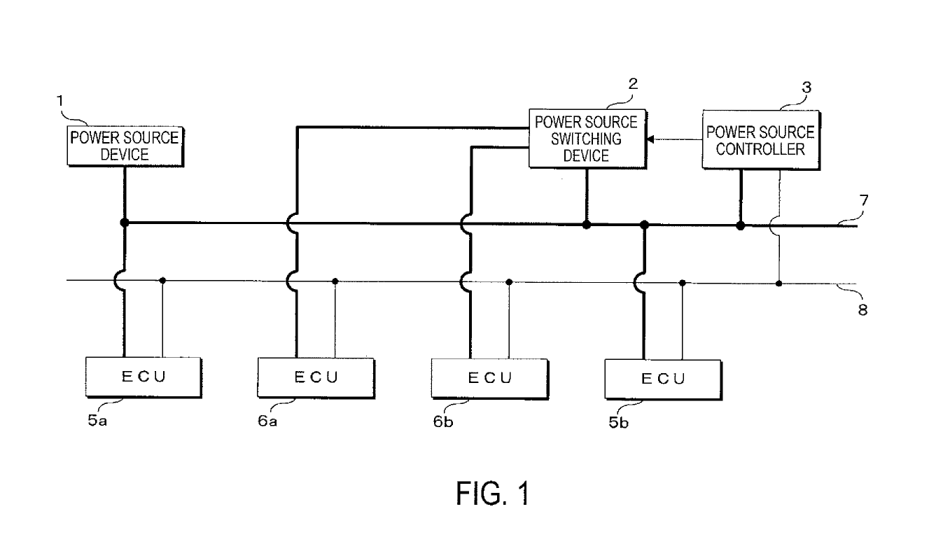

Hereinafter, the present invention will be described in detail based on the drawings showing the embodiments of the invention. FIG. 1 is a block diagram showing a configuration of a power source control system according to Embodiment 1 of the present invention. In the drawing, reference sign 1 denotes a power source device such as a battery or an alternator mounted in a vehicle. The power source device 1 mounted in the vehicle is connected to a power source switch device 2, a power source controller 3, ECUs 5a and 5b and so on that are mounted in the vehicle, via a power line 7, and supplies power to these devices. ECUs 6a and 6b mounted in the vehicle are not directly connected to the power source device 1 but connected to the power source switch device 2 via separate power lines, and receive power supplied from the power source device 1 via the power source switch device 2. The power source switch device 2 can switch between supply and shut-off of power individually for the ECUs 6a and 6b in accordance with a control signal given from the power source controller 3.

The power source controller 3 and the ECUs 5a, 5b and 6a, 6b are connected via a common communication line 8 and can communicate with one another via the communication line 8. The power source controller 3 determines whether or not to supply power to the ECUs 6a and 6b, individually for each of the ECUs 6a and 6b, based on information obtained from other devices via the communication line 8, and outputs a control signal to the power source switch device 2.

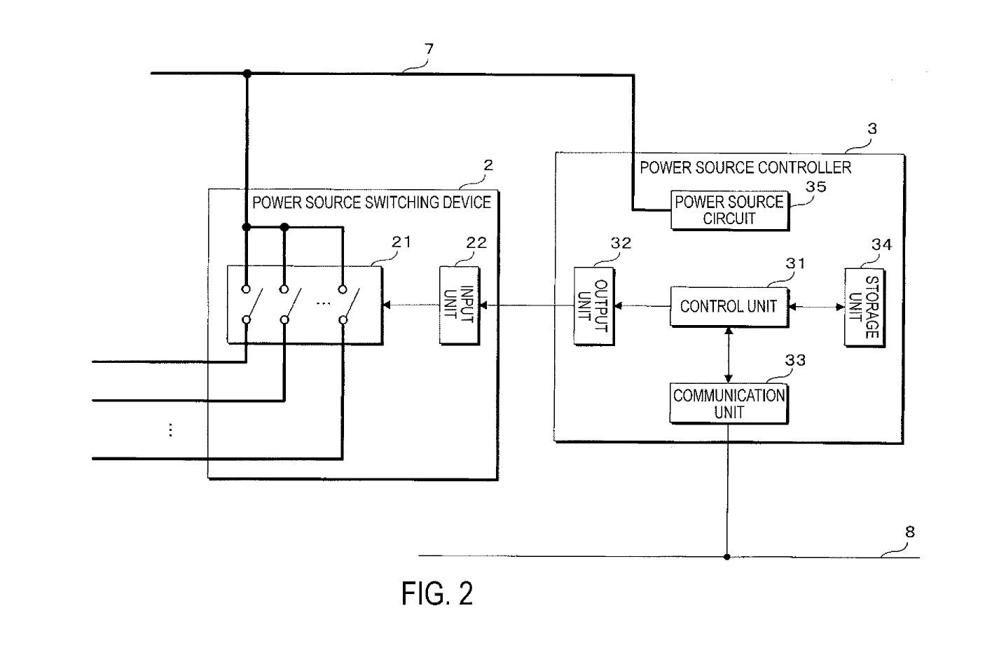

FIG. 2 is a block diagram showing a configuration of the power source switch device 2 and the power source controller 3. The power source switch device 2 is configured to include a switching unit 21 having a plurality of switches disposed on power supply paths from the power source device 1 to the ECUs 6a, 6b, and an input unit 22 for receiving input of a control signal from the power source controller 3. Each switch in the switching unit 21 can be turned on and off in accordance with the control signal input to the input unit 22. For example, a configuration is possible in which the switching unit 21 in the power source switch device 2 has N switches, the power source controller 3 outputs a N-bit control signal, and the power source switch device 2 can be configured to turn the switches on and off by associating the switches with the respective bits of the control signal.

The power source controller 3 is configured to include a control unit 31, an output unit 32, a communication unit 33, a storage unit 34, a power source circuit 35, and the like. The control unit 31 is an arithmetic circuit such as a CPU (Central Processing Unit) or an MPU (Micro Processing Unit), and performs various kinds of processing associated with power source control by loading and executing a program stored in advance in a ROM (Read Only Memory) or the like. The output unit 32 is for outputting a control signal for the power source switch device 2 in accordance with control by the control unit 31, and is an interface circuit, an output buffer, or the like.

The communication unit 33 is connected to the communication line 8 and performs communication with other devices mounted in the vehicle according to a protocol such as CAN (Controller Area Network) or LIN (Local Interconnect Network). The control unit 31 determines a vehicle status or the like based on the information received at the communication unit 33, and determines whether or not to supply power to the ECUs 6a and 6b in accordance with the determination result. The storage unit 34 is constituted by a data-rewritable memory element such as an EEPROM (Electrically Erasable Programmable ROM) or a flash memory, and stores various data necessary for control by the control unit 31. The power source circuit 35 is connected to the power source device 1 of the vehicle via the power line 7, and supplies power from the power source device 1 to each part in the power source controller 3 while appropriately adjusting voltage values/current values.

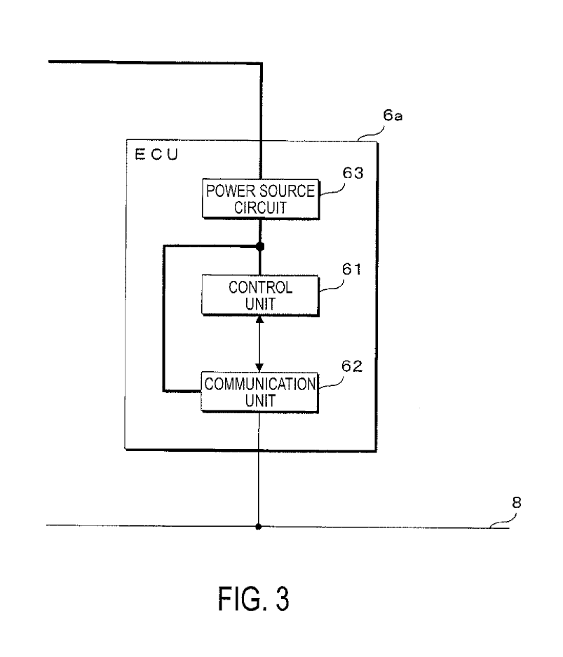

FIG. 3 is a block diagram showing a configuration of the ECU 6a. Note that the configuration of the other ECUs 5a, 5b, and 6b is substantially the same as that of the ECU 6a, and accordingly will not be shown in the figures. The ECU 6a is configured to include a control unit 61, a communication unit 62, a power source circuit 63, and the like. The control unit 61 is an arithmetic circuit such as a CPU or an MPU, and performs various kinds of processing associated with control of the vehicle by loading and executing a program stored in advance in a ROM or the like. The communication unit 62 is connected to the communication line 8, and communicates with the other ECUs 5a, 5b, 6b and so on mounted in the vehicle, according to a protocol such as CAN or LIN. The power source circuit 63 is connected to a power line, and supplies power supplied via the power line to each part in the ECU 6a while appropriately adjusting voltage values/current values.

In the power source control system according to the present embodiment, the plurality of ECUs 5a, 5b, 6a, 6b and so on share information and operate in conjunction with one another by communicating with one another via the communication line 8, thereby achieving various kinds of control processing for safe traveling of the vehicle, crime prevention for the vehicle, improvement in comfortability within the vehicle, and the like. However, not all ECUs 5a, 5b, 6a, 6b and so on mounted in the vehicle need to operate all the time. For example, ECUs for keyless entry, smart entry, a crime prevention system and the like of the vehicle do not need to operate during traveling of the vehicle, and for example, ECUs associated with traveling control such as an ABS (Anti-lock Brake System) do not have to operate while the vehicle engine is stopped. Therefore, in the power source control system according to the present embodiment, the power source controller 3 determines whether or not the ECU 6a, 6b and so on need to be operated, based on the information obtained via the communication line 8, and stops power supply for the ECU 6a, 6b and so on whose operation is determined to be unnecessary, thereby achieving a reduction in power consumption of the entire vehicle.

On the other hand, if an abnormality such as a failure occurs in any of the ECUs 5a, 5b, 6a, 6b and so on connected to the common communication line 8 and the abnormal ECU stops to operate, data cannot be received from this ECU. Accordingly, there is a possibility that the other ECUs become unable to perform normal processing either. Since safety is considered to be important in vehicles, it is necessary that a failure of any of the ECUs is detected by the other ECUs as early as possible, and that each ECU deals with the abnormality. For this reason, in the power source control system according to the present embodiment, the ECUs 5a, 5b, 6a, 6b and so on connected to the common communication line 8 transmit data at least once in a predetermined cycle (which may be different among the ECUs), and determine whether an abnormality has occurred, in accordance with whether they have received the data transmitted cyclically from the other ECUs.

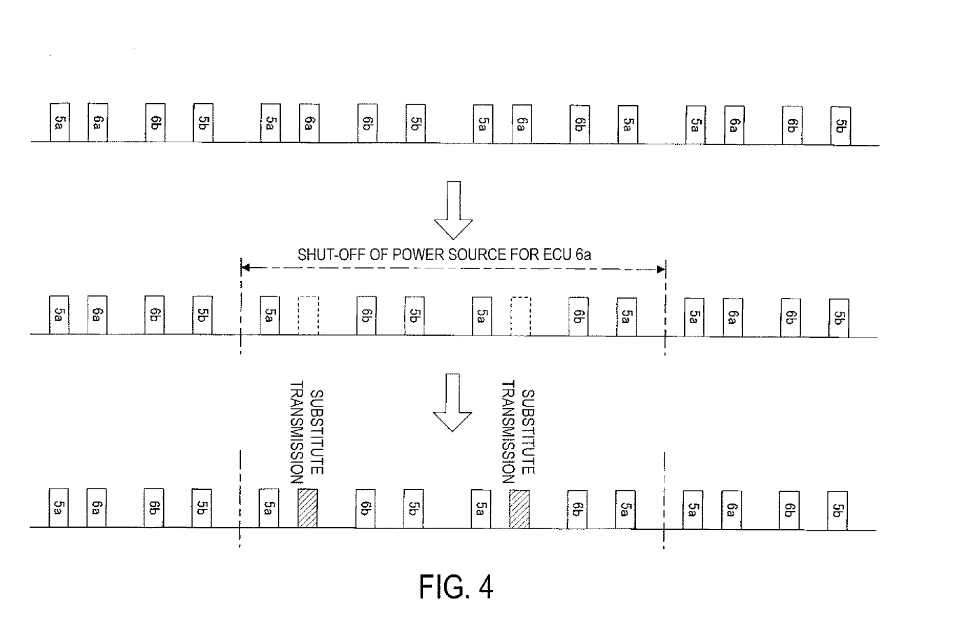

FIG. 4 is a schematic diagram for illustrating communication processing performed by the power source control system according to Embodiment 1 of the present invention, and shows data transmission by the ECUs 5a, 5b, 6a, 6b and so on (i.e., data transmitted onto the communication line 8) in the form of a timing chart. As shown in the upper part of FIG. 4, the ECUs 5a, 5b and 6a, 6b transmit data at least once in a predetermined cycle (all ECUs have the same cycle in FIG. 4).

Here, if the power source controller 3 determines to stop power supply for the ECU 6a and outputs a control signal to the power source switch device 2, a switch provided on a power source path from the power source device 1 to the ECU 6a is turned off by the switching unit 21 in the power source switch device 2. Thus, power supply for the ECU 6a is stopped (i.e., power source is shut off) and the ECU 6a stops to operate, and accordingly, cyclic data transmission is not performed by the ECU 6a during the time period in which the power source is shut off, as shown in the middle of FIG. 4. The other ECUs 5a, 5b, and 6b cannot receive data to be transmitted cyclically from the ECU 6a for which the power source is shut off, and accordingly determine that an abnormality has occurred in the ECU 6a and shift to processing for abnormality occurrence.

For this reason, in the power source control system according to the present embodiment, if, for example, the power source controller 3 performs control for shutting off the power source for the ECU 6a, the power source controller 3 performs cyclic data transmission (substitute transmission) in place of the ECU 6a for which the power source is shut off, as shown in the lower part of FIG. 4. Thus, the other ECUs 5a, 5b, and 6b can cyclically receive data that is deemed to be transmitted by the ECU 6a (but is actually transmitted by the power source controller 3), accordingly determine that the ECU 6a is naturally operating, and can perform normal processing.

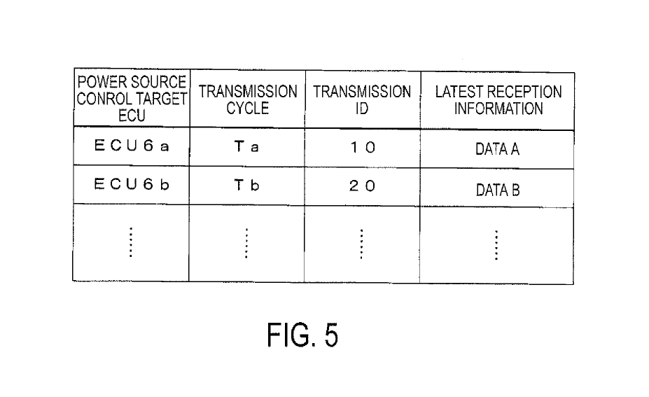

The information necessary for performing this substitute transmission is stored in advance in the storage unit 34 in the power source controller 3. If the control unit 31 performs control for shutting off the power source, it reads out the necessary information from the storage unit 34 and gives an instruction to the communication unit 33 to perform the substitute transmission. FIG. 5 is a table showing an example of information for the substitute transmission stored in the storage unit 34 in the power source controller 3. The power source controller 3 stores, in the storage unit 34, the transmission cycle, a transmission ID, and latest reception information of each ECU 6a, 6b, which are the control targets of power source shut-off, in association with one another.

The transmission cycles stored in the storage unit 34 are the cycles in which the respective ECUs 6a, 6b need to transmit data once or more, in other words, the cycles in which the other ECUs 5a, 5b and so on determine that an abnormality has occurred if they do not receive the data. The transmission IDs are identification information attached to the data subjected to the substitute transmission, and may ne device IDs or the like provided to the respective ECUs 6a, 6b, or may be message IDs provided to the respective types of transmitted data. The transmission IDs correspond to IDs included in an arbitration field of a data frame in communication according to the CAN protocol, for example.

The latest reception information stored in the storage unit 34 is information included in the data received by the power source controller 3 from the control target ECUs 6a, 6b. The latest reception information is a value included in a data field of a data frame in communication according to the CAN protocol, for example, and is information that is obtained by the power source controller 3 receiving the last data transmitted by the ECUs 6a, 6b before the power source is shut off, extracting information from the received data, and storing it in the storage unit 34.

If, for example, the power source controller 3 performs control for shutting off the power source for the ECU 6a, it reads out the transmission cycle Ta, the transmission ID 10, and the latest reception information data A that correspond to the ECU 6a, from the storage unit 34. Thereafter, the power source controller 3 generates data for transmission including the read transmission ID (10) and received information (data A), and performs substitute transmission by the communication unit 33 transmitting the generated data to the communication line 8 in the cycle Ta. The power source controller 3 continues to perform the substitute transmission for the ECU 6a until it determines to cancel the power source shut-off for the ECU 6a and resume power supply.

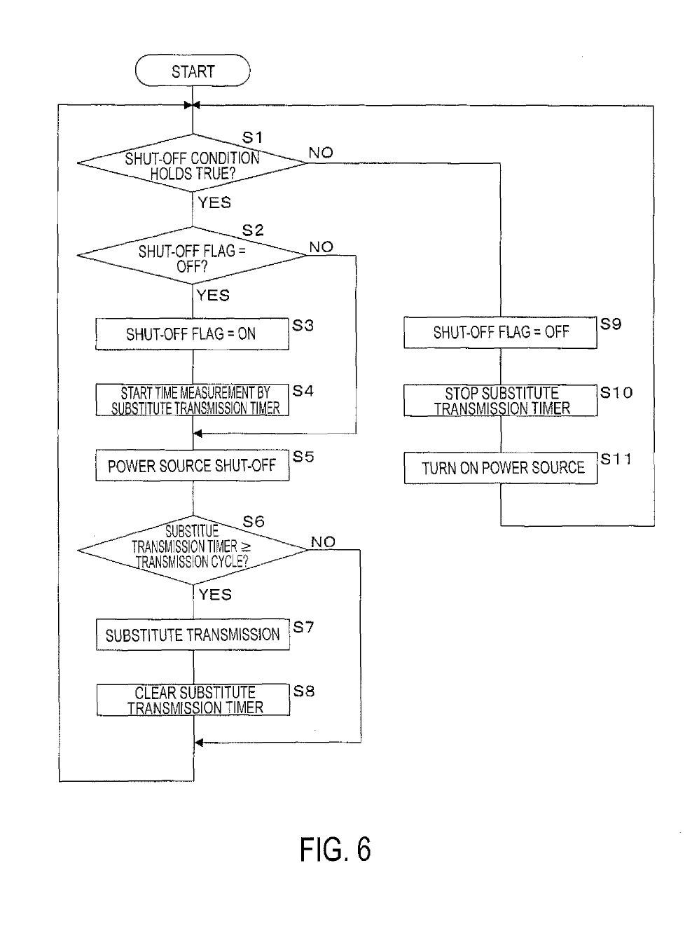

FIG. 6 is a flowchart showing a procedure of processing performed by the power source controller 3, which is processing performed at the control unit 31 in the power source controller 3. Note that the shown processing uses a shut-off flag that has a set value of “on” or “off”, and this flag is secured as a variable in a storage area such as the storage unit 34 or a register in the control unit 31. The initial value of the shut-off flag is “off”. Similarly, a substitute transmission timer is used in the shown processing, and may be one provided in the control unit 31. The shown processing is performed individually for each control target ECU 6a, 6b, and similar processing is repeatedly performed for each control target. The following is a description of processing for the ECU 6a.

The control unit 31 in the power source controller 3 initially determines whether or not a condition for stopping power supply (i.e., shutting off the power source) for the ECU 6a holds true, based on data received at the communication unit 33 from the other devices (ECUs 5a, 5b, 6a, 6b and so on) (step S1). If the shut-off condition holds true (S1: YES), the control unit 31 further determines whether or not the value of the shut-off flag is set to “off” (step S2). If the shut-off flag value is set to “off” (S2: YES), the control unit 31 sets the shut-off flag value to “on” (step S3), starts to measure time by the substitute transmission timer (step S4), and advances processing to step S5. If the shut-off flag value is set to “on” (S2: NO), the control unit 31 continues time measurement by the substitute transmission timer and advances processing to step S5.

Subsequently, the control unit 31 shuts off the power source for the ECU 6a by outputting a control signal for turning off the switch associated with power supply for the ECU 6a, to the power source switch device 2 (step S5). The ECU 6a for which the power source is shut off stops to operate. Thereafter, the control unit 31 determines whether or not the value of the substitute transmission timer is larger than or equal to the transmission cycle Ta of the ECU 6a (step S6). If the substitute transmission timer value is larger than or equal to the transmission cycle Ta (S6: YES), the control unit 31 performs the substitute transmission by transmitting data including the transmission ID and the latest reception information of the ECU 6a stored in the storage unit 34 from the communication unit 33 (step S7), clears the substitute transmission timer value (i.e., sets the value to 0) (step S8), and returns processing to step S1. If the substitute transmission timer value is smaller than the transmission cycle Ta (S6: NO), the control unit 31 continues time measurement by the substitute transmission timer, and returns processing to step S1.

If the shut-off condition does not hold true in step S1 (S1: NO), the control unit 31 sets the shut-off flag value to “off” (step S9), and stops time measurement by the substitute transmission timer (step S10). Thereafter, the control unit 31 turns on the power source for the ECU 6a by outputting a control signal for turning on the switch associated with power supply for the ECU 6a, to the power source switch device 2 (step S11), and returns processing to step S1. The ECU 6a for which the power source is turned on starts to operate.

In the power source control system with the above-described configuration, the power source controller 3 outputs a control signal to the power source switch device 2, and thus, when the power source for the ECU 6a, 6b and so on is shut off, the power source controller 3 is configured to cyclically transmit data in place of the ECU 6a, 6b and so on for which the power source is shut off. As a result, the other ECUs 5a, 5b and so on for which the power source is not shut off receive data equivalent to the data to be cyclically transmitted by the ECU 6a, 6b and so on for which the power source is shut off, from the power source controller 3, and can accordingly continue to perform regular processing without detecting an abnormality. Consequently, the power source controller 3 can switch between supply and non-supply of power to the ECUs 6a, 6b and so on, without changing the design or the like of the ECUs 5a, 5b and 6a, 6b and so on, and reduce power consumption of the entire system.

Further, the power source controller 3 is configured to store the transmission cycle, transmission ID, and latest reception information of each control target ECU 6a, 6b, in the storage unit 34, and perform the substitute transmission of data including the latest reception information. As a result, if, for example, the ECU 6a, 6b and so on transmits information regarding results of sensor detection, operational status of a switch, or the like, the power source controller 3 can perform the substitute transmission of the data including the information regarding the latest (last) detection result, operational status, or the like, and the other ECUs 5a, 5b and so on can receive this information and perform processing.

Note that although the present embodiment employs a configuration in which the latest information received from the ECU 6a, 6b for which the power source is shut off is included in the data subjected to the substitute transmission, the configuration of the present embodiment is not limited thereto, and the data subjected to the substitute transmission may include predetermined dummy information. Although the power source switch device 2 and the power source controller 3 are separate devices, they are not limited thereto, and they may be a single device. Furthermore, as described in the following variation, any of the ECUs may be equipped with the functions of the power source switch device 2 and the power source controller 3.

### Variation

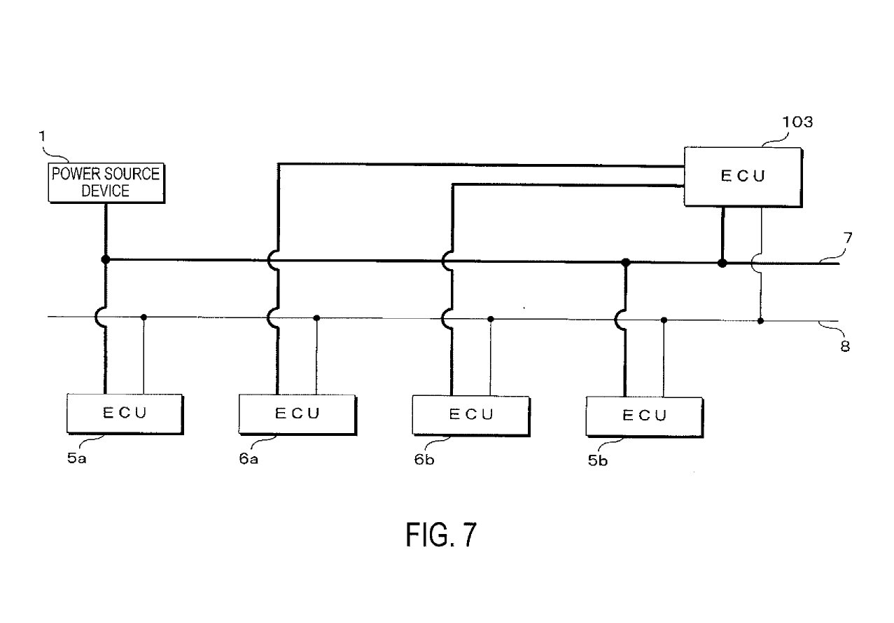

FIG. 7 is a block diagram showing a configuration of a power source control system according to a variation. The power source control system according to the variation employs a configuration in which the functions of the power source switch device 2 and the power source controller 3 shown in FIG. 1 are provided in the ECU 103, which is a body ECU or the like. For this reason, the ECU 103 performs control processing to be performed by the ECUs, such as door locking control or lighting control for the vehicle, as well as processing for control of the switching between supply and shut-off of power for the ECUs 6a, 6b and so on from the power source device 1 and substitute transmission processing when a power source is shut off as described above.

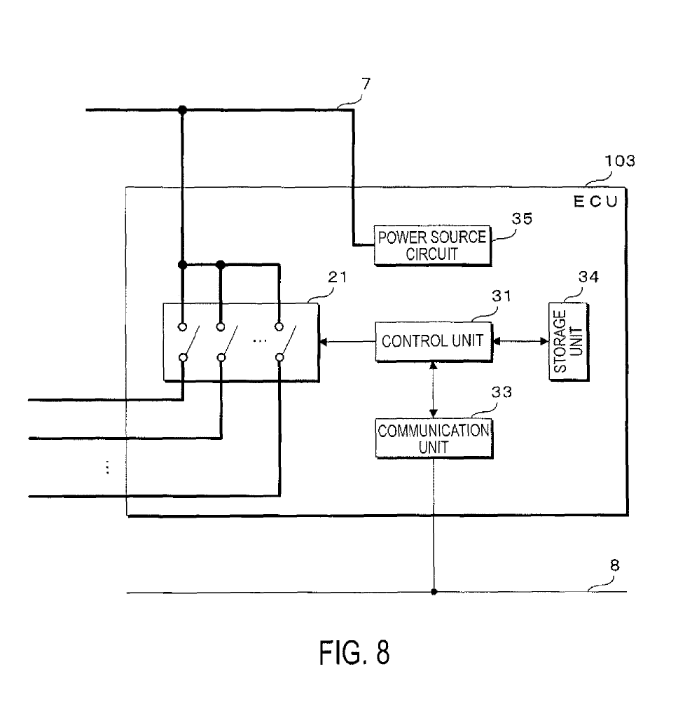

FIG. 8 is a block diagram showing a configuration of the ECU 103 according to the variation. The ECU 103 according to the variation includes a switching unit 21 that is similar to that in the power source switch device 2, and a control unit 31, a communication unit 33, a storage unit 34, and a power source circuit 35 that are similar to those in the power source controller 3. However, the turning on and off of the switches in the switching unit 21 in the ECU 103 are directly controlled by control signals output by the control unit 31. The control unit 31 in the ECU 103 performs processing for power source control, substitute transmission, and the like, which is performed by the control unit 31 in the power source controller 3, and also performs control processing such as that for door locking control or lighting control.

### Embodiment 2

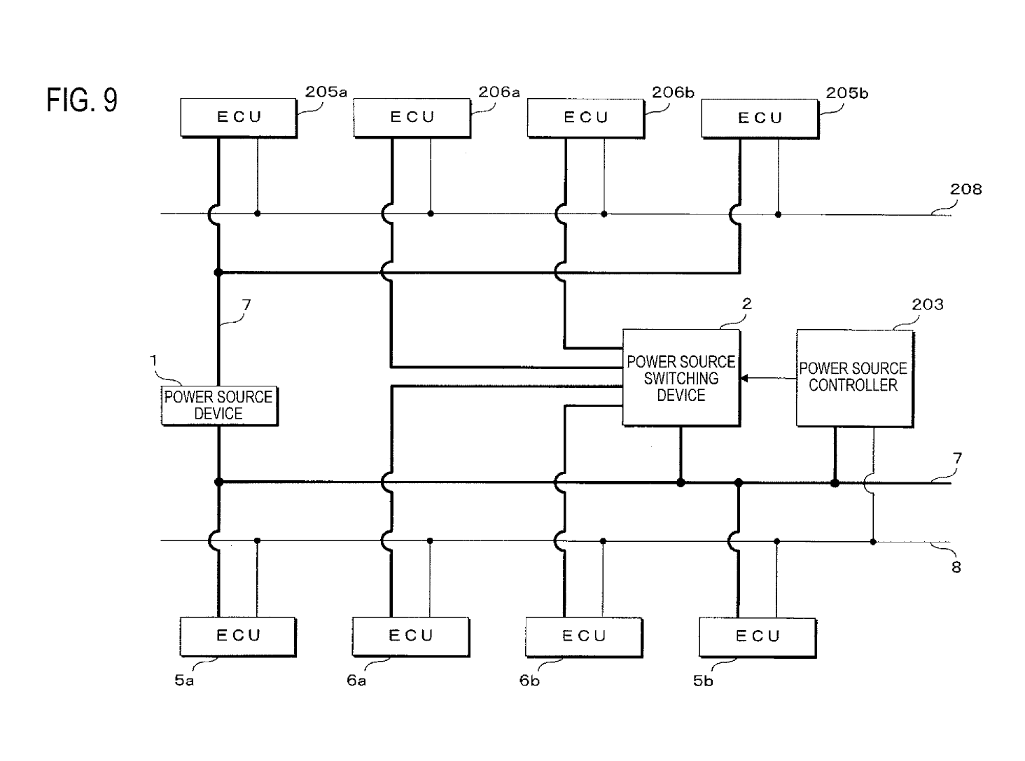

FIG. 9 is a block diagram showing a configuration of a power source control system according to Embodiment 2 of the present invention. In the power source control system according to Embodiment 2, a network including ECUs 5a, 5b, 6a, 6b and so on that are connected to a communication line 8 and a network including ECUs 205a, 205b, 206a, 206b and so on that are connected to a communication line 208 are provided in a vehicle, and these networks cannot communicate with each other. The ECUs 5a, 5b and 205a, 205b are connected to a power source device 1 via a power line, and directly receive power supplied from the power source device 1 to operate. On the other hand, the ECUs 6a, 6b and 206a, 206b receive power supplied from the power source device 1 via a power source switch device 2, and connection and disconnection of power supply paths to the respective ECUs 6a, 6b and 206a, 206h are individually controlled by a power source controller 203.

The power source controller 203 is connected to the communication line 8, and can communicate with the ECUs 5a, 5b and 6a, 6b. For this reason, if the power source switch device 2 shuts off the power source for the ECU 6a, 6b, the power source controller 203 transmits data to be cyclically transmitted by the ECU 6a, 6b for which the power source is shut off, in place of the ECU 6a, 6b (substitute transmission).

On the other hand, the power source controller 203 is not connected to the communication line 208, and cannot communicate with the ECUs 205a, 205b and 206a, 206b. Accordingly, the power source controller 203 cannot perform substitute transmission if the power source switch device 2 shuts off the power source for the ECU 206a, 206b.

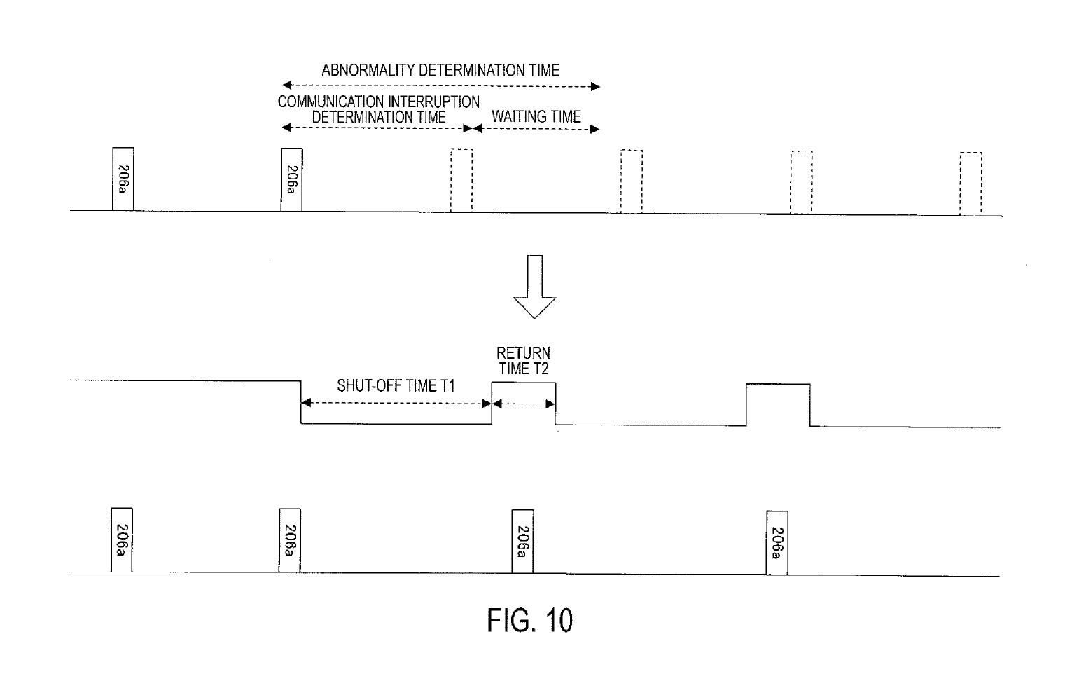

For this reason, the power source controller 203 according to Embodiment 2 intermittently shuts off the power source for the ECUs 206a, 206b for which the power source controller 203 cannot perform the substitute transmission. FIG. 10 is a schematic diagram for illustrating intermittent control performed by the power source controller 203 according to Embodiment 2, and shows data transmission of the ECU 206a and power source control for the ECU 206a in the form of timing charts. As shown in the upper part of FIG. 10, the ECU 206a cyclically transmits data, and the other ECUs 205a, 205b, and 206b determine whether or not the ECU 206a is normally operating, based on whether or not they receive the cyclic data from the ECU 206a.

For example, if processing of the ECU 206a stops and its cyclic data transmission stops due to some reason, the other ECUs 205a, 205b, and 206b detect communication interruption after a lapse of a predetermined time (communication interruption determination time transmission cycle of the ECU 206a) after the last data is received from the ECU 206a, and further determine that an abnormality has occurred in the ECU 206a if the data is not received from the ECU 206a even after a lapse of another predetermined time (waiting time). That is to say, the other ECUs 205a, 205b, and 206b determine that an abnormality has occurred in the ECU 206a after a lapse of a predetermined abnormality determination time (=communication interruption determination time+waiting time) after the last data is received from the ECU 206a. In other words, the ECU 206a need only transmit data at least once within the abnormality determination time of the other ECUs 205a, 205b, and 206b.

If the condition for shutting off the power source for the ECU 206a holds true, the power source controller 203 according to Embodiment 2 repeatedly performs power source shut-off for the ECU 206a for a predetermined time (shut-off time T1) and turning-on of the power source for the ECU 206a for a subsequent predetermined time (return time T2), as shown in the middle of FIG. 10 Note that the return time T2 is determined in accordance with the time necessary for finishing at least one data transmission after power supply for the ECU 206a is started. The total time of the shut-off time T1 and the return time T2, that is to say, the cycle of power source control for the ECU 206a is determined to be shorter than the aforementioned abnormality determination time, and the shut-off time T1 is determined based on these times.

The power source controller 203 stores in advance, in the storage unit 34, the shut-off time T1 and the return time T2 used to perform intermittent control for each control target ECU 206a, 206b. By the power source controller 203 repeatedly performing power source shut-off for the shut-off time T1 and turning-on of the power source for the return time T2, the ECU 206a can transmit data at least once within the abnormality determination time of the other ECUs 205a, 205b, and 206b as shown in the lower part of FIG. 10. Accordingly, the other ECUs 205a, 205b, and 206b can continue to perform normal processing.

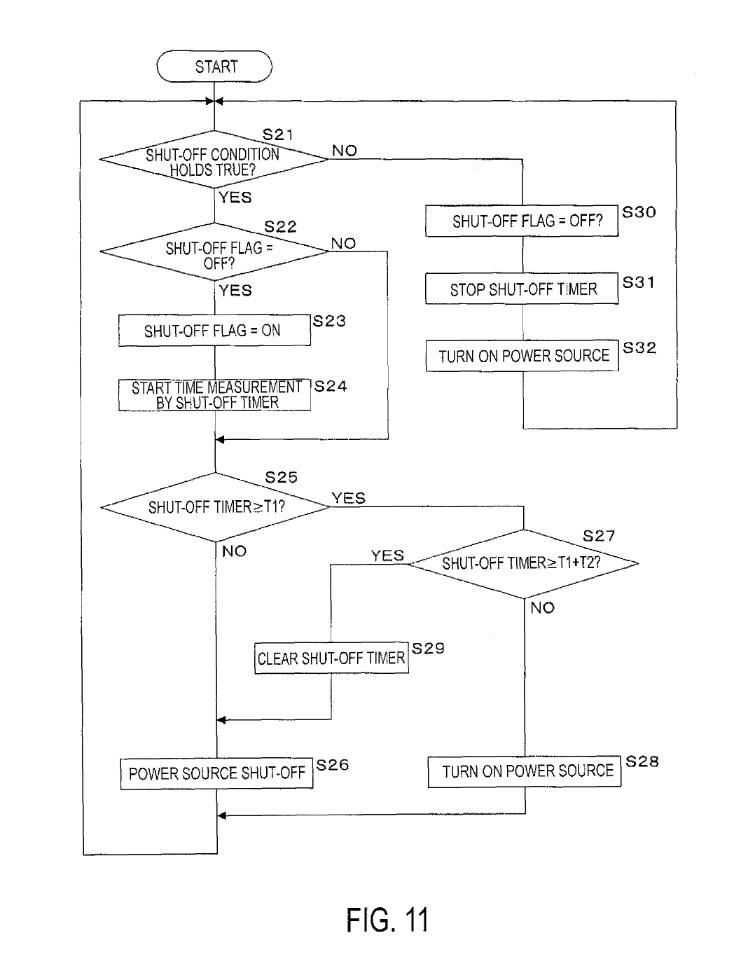

FIG. 11 is a flowchart showing a procedure of processing performed by the power source controller 203 according to Embodiment 2. Note that the shown processing uses a shut-off flag that has a set value of “on” or “off”, and this flag is secured as a variable in a storage area such as the storage unit 34 or a register in the control unit 31 in the power source controller 203. The initial value of the shut-off flag is “off”. Similarly, a shut-off timer is used in the shown processing, and may be one provided in the control unit 31. The shown processing is performed individually for each control target ECU 206a, 206b, and the similar processing is repeatedly performed for each control target. The following is a description of processing for the ECU 206a.

The control unit 31 in the power source controller 203 initially determines whether or not a condition for stopping power supply (i.e., shutting off the power source) for the ECU 206a holds true, based on the data received at the communication unit 33 from the other devices (step S21). If the shut-off condition holds true (S21: YES), the control unit 31 further determines whether or not the value of the shut-off flag is set to “off” (step S22). If the shut-off flag value is set to “off” (S22: YES), the control unit 31 sets the shut-off flag value to “on” (step S23), starts to measure time by the shut-off timer (step S24), and advances processing to step S25. If the shut-off flag value is set to “on” (S22: NO), the control unit 31 continues time measurement by the shut-off timer and advances processing to step S25.

Next, the control unit 31 determines whether or not the value of the shut-off timer is larger than or equal to the shut-off time T1 (step S25). If the shut-off timer value is smaller than the shut-off time T1 (525: NO), the control unit 31 shuts off the power source for the ECU 206a by outputting a control signal for turning off a switch associated with power supply for the ECU 206a, to the power source switch device 2 (step S26), continues time measurement by the shut-off timer, and returns processing to step S21. The ECU 206a for which the power source is shut off stops to operate.

If the shut-off timer value is larger than or equal to the shut-off time T1 (S25: YES), the control unit 31 further determines whether or not the shut-off timer value is larger than or equal to the total time of the shut-off time T1 and the return time T2 (step S27). If the shut-off timer value is smaller than the total time of the shut-off time T1 and the return time T2 (S27: NO), the control unit 31 turns on the power source for the ECU 206a by outputting a control signal for turning on a switch associated with power supply for the ECU 206a, to the power source switch device 2 (step S28), continues time measurement by the shut-off timer, and returns processing to step S21. The ECU 206a for which the power source is turned on starts to operate (i.e., is restarted) and transmits data.

If the shut-off timer value is larger than or equal to the total time of the shut-off time T1 and the return time T2 (S27: YES), the control unit 31 clears the shut-off timer value (i.e., sets the value to zero) (step S29), shuts off the power source for the ECU 206a (step S26), and returns processing to step S21. The ECU 206a for which the power source is shut off stops to operate.

If the shut-off condition does not hold true in step S21 (S21: NO), the control unit 31 sets the shut-off flag value to “off” (step S30), and stops time measurement by the shut-off timer (step S31). Thereafter, the control unit 31 turns on the power source for the ECU 206a by outputting a control signal for turning on the switch associated with power supply for the ECU 206a, to the power source switch device 2 (step S32), and returns processing to step S21. The ECU 206a for which the power source is turned on starts to operate.

The power source control system according to Embodiment 2 with the above-described configuration is configured such that the power source controller 203 shuts off the power source for the ECU 206a, 206b that is not connected to the communication line 8 shared (used in common) by the power source controller 203 and for which substitute transmission cannot be performed, only for a shorter time than the time during which the other ECUs 205a, 205b determine an abnormality. Thus, power supply for the ECU 206a, 206b is stopped without the other ECUs 205a and 205b determining that an abnormality has occurred, and power consumption of the entire system can be reduced.

Note that although the power source controller 203 in the present embodiment is configured to perform substitute transmission for the ECU 6a, 6b connected to the common communication line 8, the configuration is not limited thereto. A configuration is also possible in which the power source for the ECU 6a, 6b connected to the common communication line 8 is intermittently shut off, similarly for the ECU 206a, 206b. Further, as shown as a variation of Embodiment 1 in FIGS. 7 and 8, the functions of the power source switch device 2 and the power source controller 203 according to Embodiment 2 may be provided in the body ECU or the like.

Note that the remaining configuration of the power source control system according to Embodiment 2 is similar to that of the power source control system according to Embodiment 1, and a detailed description thereof will be omitted by providing the same reference signs to the similar constituents.

### REFERENCE SIGNS LIST

1 power source device
2 power source switch device
3 power source controller
5a, 5b ECU
6a, 6b ECU (electronic device)
7 power line
8 communication line
21 switching unit
22 input unit
31 control unit (switching control means, substitute transmission means)
32 output unit
33 communication unit (communication means, substitute transmission means)
34 storage unit (storage means)
35 power source circuit
61 control unit (detection means)
62 communication unit (communication means)
63 power source circuit
103 ECU
203 power source controller (second switching control means)
205a, 205b ECU
206a, 206b ECU (second electronic device)
208 communication line (second communication line)

1. A power source control system including a plurality of electronic devices each having a communication means for cyclically transmitting data to a common communication line to which the communication means are connected, and for receiving data cyclically transmitted from another device, and a detection means for detecting a communication abnormality if cyclic data from the other device is not received for a predetermined time period; and a power source controller having a switching control means for performing control for switching between supply and shut-off of power from a power source, individually for the respective electronic devices, the power source controller comprising:
a communication means connected to the communication line, for transmitting and receiving data to and from the electronic devices; and
a substitute transmission means for transmitting data to be cyclically transmitted by an electronic device, using the communication means, if the switching control means shuts off power for that electronic device.

2. The power source control system according to claim 1,
wherein the power source controller includes a storage means for storing identification information attached to data transmitted by the electronic devices, and cycles in which the respective electronic devices transmit data, and
the substitute transmission means is configured to transmit data including the identification information stored in the storage means in the respective cycle stored in the storage means.

3. The power source control system according to claim 1,
wherein the power source controller includes a storage means for storing data received from the electronic devices by the communication means, and
the substitute transmission means is configured to transmit data including a last data received from an electronic device for which power is shut off by the switching control means.

4. The power source control system according to claim 1,
further comprising a plurality of second electronic devices each having a communication means for cyclically transmitting data to a second communication line that is different from the communication line and to which the communication means are connected, and for receiving data cyclically transmitted from another device, and a detection means for detecting a communication abnormality if cyclic data from the other device is not received for a predetermined time period,
wherein the power source controller has a second switching control means for performing control for switching between supply and shut-off of power from a power source, individually for each second electronic device, and
the second switching control means is configured to shut off power for the second electronic devices for a shorter time period than the predetermined time period.

5. A power source controller including a switching control means for performing control for switching between supply and shut-off of power from a power source, individually for each of a plurality of electronic devices connected to a common communication line, the power source controller comprising:
a communication means for transmitting and receiving data to and from the electronic devices connected to the communication line; and
a substitute transmission means for transmitting data to be cyclically transmitted by an electronic device, using the communication means, if the switching control means shuts off power for that electronic device.

6. A power source control method for switching between supply and shut-off of power from a power source, individually for each of a plurality of electronic devices each having a communication means for cyclically transmitting data to a common communication line to which the communication means are connected, and for receiving data cyclically transmitted from another device, and a detection means for detecting a communication abnormality if cyclic data from the other device is not received for a predetermined time period, the method comprising:
transmitting data to be cyclically transmitted from an electronic device in place of the electronic device if power for the electronic device is shut off.

7. The power source control system according to claim 2,
wherein the storage means also stores data received from the electronic devices by the communication means, and
the substitute transmission means is configured to transmit data including a last data received from an electronic device for which power is shut off by the switching control means.

8. The power source control system according to claim 2,
further comprising a plurality of second electronic devices each having a communication means for cyclically transmitting data to a second communication line that is different from the communication line and to which the communication means are connected, and for receiving data cyclically transmitted from another device, and a detection means for detecting a communication abnormality if cyclic data from the other device is not received for a predetermined time period,
wherein the power source controller has a second switching control means for performing control for switching between supply and shut-off of power from a power source, individually for each second electronic device, and
the second switching control means is configured to shut off power for the second electronic devices for a shorter time period than the predetermined time period.

9. The power source control system according to claim 3,
further comprising a plurality of second electronic devices each having a communication means for cyclically transmitting data to a second communication line that is different from the communication line and to which the communication means are connected, and for receiving data cyclically transmitted from another device, and a detection means for detecting a communication abnormality if cyclic data from the other device is not received for a predetermined time period,
wherein the power source controller has a second switching control means for performing control for switching between supply and shut-off of power from a power source, individually for each second electronic device, and
the second switching control means is configured to shut off power for the second electronic devices for a shorter time period than the predetermined time period.
